(19) United States
(12) Patent Application Publication
(10) Pub. No.: US 2004/0125958 A1
(43) Pub. Date: Jul. 1, 2004

(54) Headphone for wireless use with authentication/encryption

(76) Inventors: Bruce F. Brewster, Northville, MI (US); John Pirie Hill, Hazel Park, MI (US); Dhananjay B. Kulkarni, Canton, MI (US); Thomas J. Hughes, Commerce, MI (US); Matthew Brian LaCourse, Grosse Ile, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(21) Appl. No.: 10/329,951

(22) Filed: Dec. 26, 2002

(51) Int. Cl. H04K 1/00

(52) U.S. Cl. 380/270

(57) ABSTRACT

A system for localized wireless audio communication includes a controller and headphones. The controller may be for transmitting a wireless signal representing audio information. The controller may be configured to encode the audio information. The headphones may be configured to receive the wireless signal and reproduce the audio information, wherein encoding the audio information includes providing an authentication uniquely associating the controller and the headphones, and reproducing the audio information includes verifying the authentication so that audio information represented by wireless signals from a source other than the controller is not reproduced.

### BACKGROUND OF THE INVENTION

1. Field of the Invention

The present invention relates to headphones, generally, and more particularly, to wireless headphones for use with authentication and encryption.

2. Background Art

Many conventional automotive rear entertainment systems implement wireless headphones so that users (i.e., passengers) can listen to audio such as radio, tape, MP3, VCR, and DVD-audio content without being encumbered by wires between the headphones and the audio source. Similarly, some conventional home entertainment systems are implemented having wireless headphones that provide similar benefits to users in the home. A number of industrial applications (e.g. systems for audio communication in a noisy environment, “hands free” environments, etc.) implement wireless headphones. The wireless transmission between the audio source and the headphones is via radio frequency, infrared, ultrasonic or other appropriate wireless waves in connection with a communication protocol (e.g., Bluetooth, IEEE 802.11b, etc.).

The audio content from some media, especially program content such as found in some movies played on in-vehicle or in-home VCRs and DVDs, may not be suitable for children and sensitive adults. Even though wireless headphone audio signals are generally limited range transmissions, when vehicles are it close proximity, the wireless headphone audio signals from one vehicle can sometimes be received and reproduced in other nearby vehicles. Similarly, home entertainment system headphones used in houses that are in close proximity, vehicles that are in close proximity to houses, etc. can receive and reproduce potentially offensive, unwanted or unauthorized wireless audio signals. In an industrial setting, inadvertently or unintentionally received wireless headphone signals can compromise security and safety.

Some conventional VCRs and DVDs implement V chip technology that provides a method of screening the program content. However, V chip technology blocks entire programs and thus prevents non-sensitive users from enjoying the program entirely. Other conventional technologies filter out or substitute unoffensive words in the program audio content as the program is played or watched. However, such filter technology is not 100% effective and also prevents non-sensitive users from enjoying the original program content.

Conventional communication techniques such as frequency hopping and spread spectrum are often implemented in connection with the wireless headphone signal communication protocol. However, frequency hopping and spread spectrum technologies are more suited to signal level matching and reducing effects of electromagnetic interference than signal security. Furthermore, while some communication protocols provide authentication and/or encryption techniques, such conventional technique implementations generally lack robustness and may not reduce or prevent the unintended and unauthorized reception and listening of audio content in or from nearby sources.

Thus, there exists a need for a system and method for wireless headphones for automotive use that reduces or prevents the unauthorized reception and listening of automotive rear entertainment system audio content in or from nearby vehicles. Such an improvement would, thereby, enable the playback of any program content on automotive rear entertainment systems equipped with wireless headphone communication without unauthorized wireless headphone users in nearby vehicles either intentionally or inadvertently listening to potentially offensive audio content. Such an improvement may also be implemented in connection with a home entertainment system (or similar application) having wireless headphones. In another example, the wireless headphone system of the present invention may be implemented in an industrial audio communication system.

### SUMMARY OF THE INVENTION

Accordingly, in one example the present invention provides an improved wireless headphone communication system that is particularly suitable for automotive rear entertainment system player applications where the wireless headphone communication system includes wireless signals that are authenticated to reduce or prevent intentional or inadvertent unauthorized listening by users in nearby vehicles. The wireless signals may also be encrypted to reduce or prevent intentional or inadvertent unauthorized listening by users in nearby vehicles. In another example, the present invention provides an improved system and an improved method for reducing or preventing intentional or inadvertent listening for a home entertainment system application having wireless headphones. In yet another example, the improved wireless headphone system of the present invention may be implemented in connection with an industrial application.

According to the present invention, a system for localized wireless audio communication is provided comprising a controller and headphones. The controller may be for transmitting a wireless signal representing audio information. The controller may be configured to encode the audio information. The headphones may be configured to receive the wireless signal and reproduce the audio information, wherein encoding the audio information comprises providing an authentication uniquely associating the controller and the headphones, and reproducing the audio information comprises verifying the authentication so that audio information represented by wireless signals from a source other than the controller is not reproduced.

Also according to the present invention, in an audio communication system including a controller and headphones, a method for localized wireless audio communication is provided comprising encoding at the controller audio information including providing an authentication uniquely associating the controller and the headphones, transmitting from the controller a wireless signal representing the audio information, receiving at the headphones the wireless signal, and reproducing at the headphones the audio information including verifying the authentication so that audio information represented by wireless signals from a source other than the controller is not reproduced.

Still further according to the present invention, in a vehicle entertainment system, a system for localized wireless audio communication is provided comprising a controller and headphones. The controller may be for transmitting a wireless signal representing audio information. The controller may be configured to encode the audio information. The headphones may be configured to receive the wireless signal and reproduce the audio information, wherein encoding comprises encrypting the audio information to uniquely associate the controller and the headphones, and reproducing the audio information comprises decrypting so that audio information represented by wireless signals received from a source other than the controller is not reproduced.

The above features, and other features and advantages of the present invention are readily apparent from the following detailed descriptions thereof when taken in connection with the accompanying drawings.

### BRIEF DESCRIPTION OF THE DRAWINGS

FIG. 1 is a diagram illustrating a wireless headphone system in accordance with a preferred embodiment of the present invention; and

FIG. 2 is a diagram illustrating a waveform of the wireless headphone system of the present invention.

### DETAILED DESCRIPTION OF THE PREFERRED EMBODIMENT(S)

With reference to the Figures, the preferred embodiments of the present invention will now be described in detail. Generally, the present invention provides a system and method for localized wireless headphone system use that reduces or prevents the unauthorized reception and reproduction of the system wireless audio signal content. The present invention generally provides for broadcast and reproduction of audio program content in communication systems equipped with wireless headphone communication via authenticated and encrypted signals. The present invention generally reduces or prevents unauthorized nearby wireless headphone or other receivers either intentionally or inadvertently listening to potentially offensive, unauthorized or unwanted audio content.

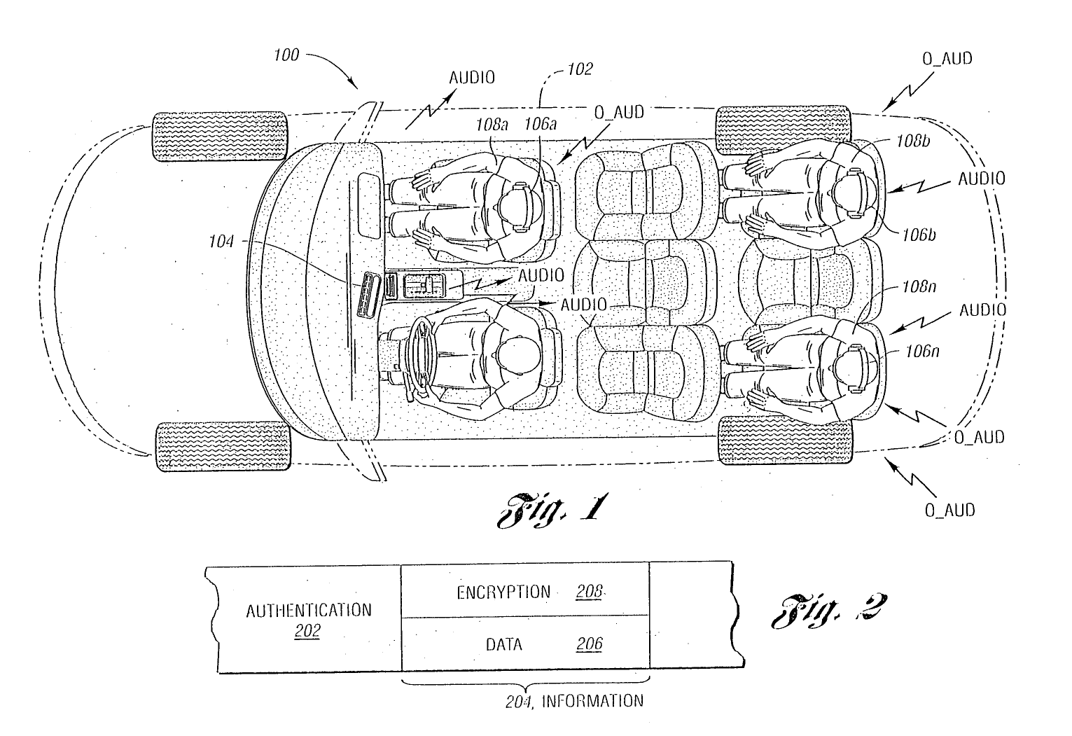

Referring to FIG. 1, a diagram illustrating a localized wireless headphone audio communication system 100 in accordance with the present invention is shown. In one example, the system 100 may be implemented in connection with a vehicle (e.g., automotive, car, truck, sport utility vehicle, van, mini-van, multi-purpose vehicle, etc.) application. The system 100 generally comprises a vehicle 102 having an media player including a controller 104, where at least one set of headphones 106 (e.g., headphones 106a-106n) are worn by at least one respective user (e.g., vehicle passenger) 108 (e.g., users 108a-108n). Since the player that includes the controller 104 is generally directed to providing entertainment for vehicle passengers, the vehicle 102 driver does not generally wear headphones.

The controller 104 is generally implemented in connection with a rear entertainment system video cassette recorder/player (VCR) or a digital video disk (DVD) media player. In one example, the controller 104 may be implemented in connection with a stand-alone unit. In another example, the controller 104 may be integrated into an entertainment system that comprises media having at least one audio portion such as radio, television, audio cassette, digital audio tape (DAT), compact disk (CD), laser disk, mini-disk, MP3, etc. as well as components to meet the design criteria of a particular application.

The controller 104 is generally configured to encode and present (i.e., transmit, broadcast, etc.) a wireless signal (e.g., AUDIO). The signal AUDIO generally comprises a digitally encoded representation of an audio portion of programming content of the media played through the controller 104 (e.g., the audio portion of a movie that is being watched on an in-vehicle VCR or DVD player). The signal AUDIO is generally transmitted via radio frequency, infrared, ultrasonic or other appropriate wireless waves. The signal AUDIO is generally transmitted via a standard communication protocol (e.g., Bluetooth, IEEE 802.11b, etc.). The transmission of the encoded audio signal AUDIO may be implemented having frequency hopping and spread spectrum transmission technology. However, the signal AUDIO may be transmitted via any appropriate protocol to meet the design criteria of a particular application.

The signal AUDIO may be implemented having validation (e.g., authentication and encryption technologies) in addition to conventional authentication and encryption techniques that may be implemented in connection with the communication protocol. Reproduction of the signal AUDIO may be localized to the headphones 106. The signal AUDIO is described in more detail in connection with FIG. 2.

The headphones 106 generally comprise a wireless signal receiver and an audio reproduction device. The headphones 106 may be configured to receive, validate, and decode the signal AUDIO (i.e., reproduce the audio content of the program being played via the controller 104).

The headphones 106 may receive at least one additional wireless signal (e.g., O_AUD). The signal O_AUD may be generated as an audio content signal that is transmitted by a nearby source (not shown) other than the player 104. Since the headphones 106 are generally configured to receive the signal AUDIO, determine if the authentication and encryption of the signal AUDIO is valid, and reproduce the audio content of the program being played on the controller 104, the content of the signal O_AUD is generally not reproduced by the headphones 106. Similarly, headphones (or receivers) other than the headphones 106 that may receive the signal AUDIO are generally unable to reproduce the audio content of the program being played on the controller 104 (i.e., the signal AUDIO may be localized to the headphones 106). The signal AUDIO will generally not be a valid signal to receivers other than the headphones 106.

In another example, the system 100 may be implemented in connection with a home entertainment system (not shown). The controller 104 may be implemented in connection with a home media player such as a VCR, a DVD player, radio, television, etc. In yet another example, the system 100 may be implemented in connection with an industrial audio communication system (not shown). The controller 104 may be implemented in connection with a broadcast console or the like. The headphones 106 may be worn by users 108 in a noisy environment or in a setting where “hands free” communication is advantageous. However, the system 100 may be advantageously implemented in any appropriate localized wireless headphone audio communication application where the reduction or elimination of offensive, unauthorized or unwanted audio signals is desirable.

Thus, the system 100 is configured such that potentially offensive, unauthorized or unwanted wireless audio signals that are transmitted by the controller 104 are not generally reproducible by nearby users that may purposefully or inadvertently receive the signal AUDIO. Similarly, the signal O_AUD that originates from sources other than the controller 104 may have offensive, unauthorized or unwanted content that is not reproducible by the headphones 106 of the present invention. Users of the system 100 of the present invention may be confident that sensitive, unauthorized or unwanted listeners who receive the signal broadcast by the controller 104 (i.e., the signal AUDIO) are generally not be able to understand the received signal since the signal AUDIO can not generally be reproduced by a receiver other than the headphones 106. Users of the system 100 may also be confident that sensitive, unauthorized or unwanted users (e.g., children, unauthorized workers, etc.) who wear the headphones 106 generally only hear the content of what is played on the controller 104 and not other audio content from nearby sources (e.g., the potentially offensive, unauthorized or unwanted content of the signal O_AUD).

Referring to FIG. 2, a diagram of a waveform 200 in accordance with the present invention is shown. The waveform 200 may represent the signal AUDIO. The waveform 200 is generally encoded to comprise an authentication portion (or segment) 202 and an information portion (or segment) 204.

The authentication portion 202 is generally implemented as an identifier that uniquely links (or associates) the vehicle 102 (or the controller 104) to the headphones 106. The association (or authentication) portion 202 generally provides verification that the signal AUDIO corresponds to (i.e., is linked to associated with, etc.) the controller 104 and the headphones 106. The controller 104 and the headphones 106 are, thereby, uniquely associated (or linked).

In contrast, the authentication provided by many conventional communication protocols merely identifies the type of receiver (e.g., headphones) and the manufacturer (or vendor). In one example, the authentication portion 202 may correspond to a vehicle identification number (VIN) that uniquely identifies the vehicle 102. However, the authentication portion 202 may be implemented as any appropriate identifier to meet the design criteria of a particular application. The authentication portion 202 is generally implemented in addition (or supplemental) to authentication techniques that may be implemented in connection with the communication protocol that is used for encoding and transmitting the signal AUDIO.

The headphones 106 are generally implemented to only reproduce signals that are implemented having the particular authentication portion 202 (i.e., the unique identifier) that correspond to the controller 104 (or the vehicle 102). Signals (e.g., the signal O_AUD) that may be received by the headphones 106 and that have a similar communication protocol to the signal AUDIO but do not have the valid authentication segment 202 are generally not reproduced by the headphones 106.

The information portion 204 generally comprises a data portion 206 and an encryption portion 208. The data portion 206 generally corresponds to the audio content of the programming that is being played by the controller 104. The encryption portion 208 is generally implemented having encryption technologies in addition (or supplemental) to encryption techniques that may be implemented in connection with the communication protocol that is used for encoding and transmitting the signal AUDIO. The encryption portion 208 generally provides validation (or association) to the signal AUDIO (i.e., between the controller 104 and the headphones 106).

In one example, the encryption portion 208 may be implemented as pseudo-random noise that is added to the signal AUDIO by the controller 104 prior to the broadcast (or transmission) of the signal AUDIO and removed or cancelled by the receiver portion of the headphones 106 during the reproduction operation. Since the encryption portion 208 is pseudo-random noise, any signal AUDIO that is reproduced by receivers other that the headphones 106 will generally be invalid (i.e., garbled and incomprehensible). Similarly, any signal O_AUD that is reproduced by the headphones 106 will generally be garbled and incomprehensible.

In another example, the controller 104 may be configured to provide encryption by programatically modifying (i.e., encrypting) the data portion 206 via the encryption portion 208. For example, the waveform 200 (i.e., the signal AUDIO) may be implemented as a key code encrypted signal. The encryption portion 208 may be implemented in connection with a multi-bit key that is unique to the controller 104 and the headphones 106. The controller 104 and the headphones 106 may be linked via key code encryption. However, the data portion 206 may be encrypted via any appropriate encryption technique to meet the design criteria of a particular application. Since the signal AUDIO is encrypted, any signal AUDIO that is reproduced by receivers other that the headphones 106 will generally be invalid, garbled and incomprehensible. Similarly, a signal that is not properly encrypted (e.g., the signal O_AUD) that is reproduced by the headphones 106 will generally be garbled and incomprehensible.

The present invention may provide an automotive or home entertainment system player including a controller that utilizes wireless communication techniques to communicate the audio portion of the entertainment system signal to headphones worn by vehicle passengers or home users using the entertainment system. The present invention may use an authentication portion of the signal to provide the controller and headphones with unique vehicle or entertainment system authentication and signal encryption techniques (i.e., association or linking), thereby allowing the headphones to selectively reproduce the audio signal from only the correct vehicle or controller. Similarly, nearby receivers (e.g., headphones that are components of nearby vehicle or home entertainment systems) that do not have the proper authentication and encryption (i.e., signal validation) of the present invention generally are not able to reproduce the audio content of the program played by the entertainment system of the present invention. In an industrial setting, the present invention may reduce or prevent wireless headphone users from intentionally or inadvertently intercepting or receiving unauthorized or unwanted audio signals.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for localized wireless audio communication comprising:
a controller for transmitting a wireless signal representing audio information, the controller configured to encode the audio information; and
headphones configured to receive the wireless signal and reproduce the audio information, wherein encoding the audio information comprises providing an authentication uniquely associating the controller and the headphones, and reproducing the audio information comprises verifying the authentication so that audio information represented by wireless signals from a source other than the controller is not reproduced.

2. The system of claim 1 wherein encoding further comprises encryption.

3. The system of claim 1 wherein the system comprises an entertainment system having a video cassette recorder or a digital video disk player.

4. The system of claim 1 wherein the authentication comprises a vehicle identification number.

5. The system of claim 2 wherein encryption comprises adding pseudo-random noise to the wireless signal.

6. The system of claim 2 wherein encryption comprises key code encryption.

7. The system of claim 2 wherein encryption is supplemental to a communication protocol encryption.

8. The system of claim 1 wherein transmitting the wireless signal comprises using a communication protocol selected from the group consisting of Bluetooth and IEEE 802.11b.

9. In an audio communication system including a controller and headphones, a method for localized wireless audio communication comprising:
encoding at the controller audio information including providing an authentication uniquely associating the controller and the headphones;
transmitting from the controller a wireless signal representing the audio information;
receiving at the headphones the wireless signal; and
reproducing at the headphones the audio information including verifying the authentication so that audio information represented by wireless signals from a source other than the controller is not reproduced.

10. The method of claim 9 wherein encoding further comprises providing encryption.

11. The method of claim 10.wherein encryption is supplemental to a communication protocol encryption.

12. The method of claim 10 wherein encryption comprises adding pseudo-random noise to the wireless signal.

13. The method of claim 10 wherein encryption comprises key code encryption.

14. The method of claim 9 wherein the communication system, comprises an entertainment system having a video cassette recorder or a digital video disk player.

15. The method of claim 9 wherein authentication comprises a vehicle identification number.

16. The method of claim 9 wherein transmitting the wireless signal comprises using a communication protocol selected from the group consisting of Bluetooth and IEEE 802.11b.

17. In a vehicle entertainment system, a system for localized wireless audio communication comprising:
a controller for transmitting a wireless signal representing audio information, the controller configured to encode the audio information; and
headphones configured to receive the wireless signal and reproduce the audio information, wherein encoding comprises encrypting the audio information to uniquely associate the controller and the headphones, and reproducing the audio information comprises decrypting so that audio information represented by wireless signals received from a source other than the controller is not reproduced.

18. The communication system of claim 17 wherein encoding further comprises authentication.

19. The communication system of claim 17 wherein encryption comprises adding pseudo-random noise to the wireless signal.

20. The communication system of claim 17 wherein encryption comprises key code encryption.
